(19) United States
(12) Patent Application Publication
(10) Pub. No.: US 2022/0114457 A1
(43) Pub. Date: Apr. 14, 2022

(54) QUANTIZATION OF TREE-BASED MACHINE LEARNING MODELS

(71) Applicant: QEEXO, CO., Mountain View, CA (US)

(72) Inventors: Leslie J. Schradin, III, Pittsburgh, PA (US); Qifan He, Pittsburg, PA (US)

(73) Assignee: QEEXO, CO., Mountain View, CA (US)

(21) Appl. No.: 17/498,660

(22) Filed: Oct. 11, 2021

Related U.S. Application Data
(60) Provisional application No. 63/090,516, filed on Oct. 12, 2020.

(51) Int. Cl. G06N 5/02; G06N 5/00; G06N 5/04

(52) U.S. Cl. CPC G06N 5/022; G06N 5/04; G06N 5/003

(57) ABSTRACT

Provided are various mechanisms and processes for quantization of tree-based machine learning models. A method comprises determining one or more parameter values in a trained tree-based machine learning model. The one or more parameter values exist within a first number space encoded in a first data type and are quantized into a second number space. The second number space is encoded in a second data type having a smaller file storage size relative to the first data type. An array is encoded within the tree-based machine learning model. The array stores parameters for transforming a given quantized parameter value in the second number space to a corresponding parameter value in the first number space. The tree-based machine learning model may be transmitted to an embedded system of a client device. The one or more parameter values correspond to threshold values or leaf values of the tree-based machine learning model.

### CROSS-REFERENCE TO RELATED APPLICATIONS

This application claims the benefit under 35 U.S.C. § 119(e) of U.S. Provisional Patent Application No. 63/090,516, entitled: “QUANTIZATION OF TREE-BASED MACHINE LEARNING MODELS” (Attorney Docket No. QEEXP025P) filed on Oct. 12, 2020, which is incorporated herein by reference in its entirety for all purposes.

### TECHNICAL FIELD

The present disclosure relates generally to machine learning models, and more specifically to tree-based machine learning models.

### BACKGROUND

Many commercial applications have adopted machine learning models to improve performance, including neural networks and tree-based machine learning methods. However, such machine learning models increase demands on computation, power, and memory resources, which may reduce performance, especially on hardware with limited capacity, such as embedded chips or platforms that do not include general-purpose central processing unit (CPU) chips. In such environments, the reduced flash and RAM may preclude storing or loading the machine learning model.

Therefore, there is a need to reduce computation and resource demands of machine learning models.

### SUMMARY

The following presents a simplified summary of the disclosure in order to provide a basic understanding of certain embodiments of the disclosure. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

In general, certain embodiments of the present disclosure describe systems and methods for quantization of tree-based machine learning models. The method comprises determining one or more parameter values in a trained tree-based machine learning model. The one or more parameter values exist within a first number space encoded in a first data type.

The method further comprises quantizing the one or more parameter values into a second number space. The second number space is encoded in a second data type having a smaller file storage size relative to the first data type. An array is encoded within the tree-based machine learning model. The array stores parameters for transforming a given quantized parameter value in the second number space to a corresponding parameter value in the first number space. The method further comprises transmitting the tree-based machine learning model to a client device.

The tree-based machine learning model may be transmitted to an embedded system of the client device. The method may further comprise obtaining a datapoint via a sensor of the embedded system, and extracting a feature from the datapoint. The method may further comprise passing the extracted feature through the tree-based machine learning model. The method may further comprise un-quantizing the one or more parameter values from the second number space to the first number space, and generating a prediction for the feature based on the one or more un-quantized parameter values. Each of the one or more parameter values may be un-quantized as needed as the extracted feature is processed at nodes corresponding to the one or more parameter values.

The one or more parameter values may correspond to threshold values for a feature of the tree-based machine learning model. The one or more parameter values may correspond to leaf values of the tree-based machine learning model. The first data type may be a 32-bit floating-point type. The second data type may be an 8-bit unsigned integer. The one or more parameter values correspond to threshold values and leaf values, and threshold values and leaf values are quantized independently from one another.

The tree-based machine learning model may be configured to classify gestures corresponding to motion of the client device.

Other implementations of this disclosure include corresponding devices, systems, and computer programs corresponding to the described methods. These other implementations may each optionally include one or more of the following features. For instance, provided is a system for quantization of tree model parameters. The system comprises one or more processors, memory, and one or more programs stored in the memory. The one or more programs comprise instructions for performing the actions of the described methods and systems. Also provided are one or more non-transitory computer readable media having instructions stored thereon for performing the described methods and systems.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a diagram of an example network architecture for implementing various systems and methods of the present disclosure, in accordance with one or more embodiments.

FIG. 2 illustrates a process flow chart for quantization of a tree-based machine learning model, in accordance with one or more embodiments.

FIG. 3 illustrates an example tree-based machine learning model, in accordance with one or more embodiments.

FIG. 4 illustrates an architecture of a mobile device which can be used to implement a specialized system incorporating the present teaching, in accordance with one or more embodiments.

FIG. 5 illustrates a particular example of a computer system that can be used with various embodiments of the present disclosure.

### DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. Furthermore, the techniques and mechanisms of the present disclosure will sometimes describe a connection between two entities. It should be noted that a connection between two entities does not necessarily mean a direct, unimpeded connection, as a variety of other entities may reside between the two entities. Consequently, a connection does not necessarily mean a direct, unimpeded connection unless otherwise noted.

Overview

The general purpose of the present disclosure, which will be described subsequently in greater detail, is to provide a system and method for quantizing tree-based machine learning models to reduce model size and computational demands.

There are situations in which it is desirable for a machine learning model to require as few bytes, or memory, as possible. For example, flash and RAM memory are often limited for embedded devices or systems. Machine learning models consume flash and RAM memory, increase computation, and increase power demands. This may result in reduced performance, especially on hardware with limited capacity, such as embedded chips. On such chips, the small flash and RAM may preclude storing or loading the machine learning model in the first place. Decreasing the memory resource demands of machine learning models is especially important for embedded chips, which have a lot less memory (both flash and RAM) than CPUs. This may be particularly relevant to platforms that do not have general-purpose CPU chips at all, where embedded chips are the most powerful processors available.

There are also situations in which it is desirable for the machine learning model to only use integer parameter values. For example, some embedded devices do not have a floating-point unit, and performing floating-point operations on these devices may be prohibitively expensive in terms of central processing unit (CPU) time, latency, and power. Quantization of machine learning models, and in particular tree models, can address these issues: quantization usually leads to a smaller model size, and quantization often leads to integer data types being used for parameters instead of float-valued data types.

Quantization of tree models also provides added flexibility in the design structure of the tree model to reduce the ultimate file storage size. For example, threshold parameter values of decision nodes and leaf parameter values of terminal nodes may be quantized independently of each other. Furthermore, threshold values corresponding to different features may also be quantized independently of each other. The systems and methods described herein can be applied in any situation in which a tree-based model is being used for machine learning, regardless of the desired application of the machine learning model.

Detailed Embodiments

Turning now descriptively to the drawings, in which similar reference characters denote similar elements throughout the several views, the attached figures illustrate systems and methods for automated pairing of incoming leads.

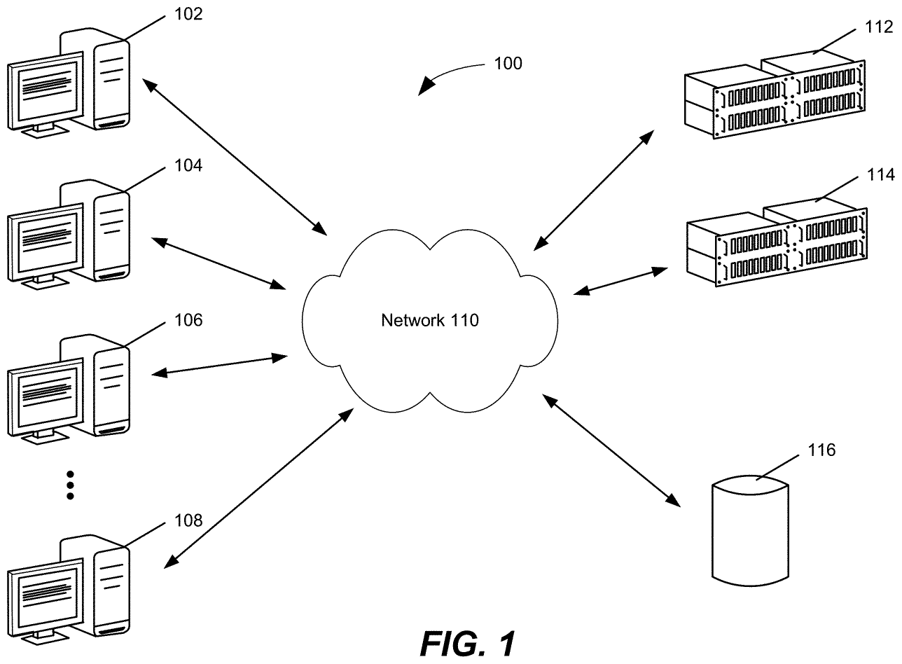

According to various embodiments of the present disclosure, FIG. 1 illustrates a diagram of an example network architecture 100 for implementing various systems and methods of the present disclosure, in accordance with one or more embodiments. The network architecture 100 includes a number of client devices (or “user devices”) 102-108 communicably connected to one or more server systems 112 and 114 by a network 110. In some implementations, the network 110 may be a public communication network (e.g., the Internet, cellular data network, dial up modems over a telephone network) or a private communications network (e.g., private LAN, leased lines).

In some embodiments, server systems 112 and 114 include one or more processors and memory. The processors of server systems 112 and 114 execute computer instructions (e.g., network computer program code) stored in the memory to process, receive, and transmit data received from the various client devices. In some embodiments, server system 112 is a content server configured to receive, process, and/or store historical data sets, parameters, and other training information for a machine learning model. In some embodiments server system 114 is a dispatch server configured to transmit and/or route network data packets including network messages. In some embodiments, content server 112 and dispatch server 114 are configured as a single server system that is configured to perform the operations of both servers.

In some embodiments, the network architecture 100 may further include a database 116 communicably connected to client devices 102-108 and server systems 112 and 114 via network 110. In some embodiments, network data, or other information such as computer instructions, historical data sets, parameters, and other training information for a machine learning model may be stored in and/or retrieved from database 116.

Users of the client devices 102-108 access the server system 112 to participate in a network data exchange service. For example, the client devices 102-108 can execute web browser applications that can be used to access the network data exchange service. In another example, the client devices 102-108 can execute software applications that are specific to the network (e.g., networking data exchange “apps” running on devices, such as computers, smartphones, or sensor boards).

Users interacting with the client devices 102-108 can participate in the network data exchange service provided by the server system 112 by distributing and retrieving digital content, such as software updates, location information, payment information, media files, or other appropriate electronic information. In some embodiments, network architecture 100 may be a distributed, open information technology (IT) architecture configured for edge computing.

In some implementations, the client devices 102-108 can be computing devices such as laptop or desktop computers, smartphones, personal digital assistants, portable media players, tablet computers, or other appropriate computing devices that can be used to communicate through the network. In some implementations, the server system 112 or 114 can include one or more computing devices such as a computer server. In some implementations, the server system 112 or 114 can represent more than one computing device working together to perform the actions of a server computer (e.g., cloud computing). In some implementations, the network 110 can be a public communication network (e.g., the Internet, cellular data network, dial up modems over a telephone network) or a private communications network (e.g., private LAN, leased lines).

In various embodiments, server system 112 or 114 may be an edge computing device configured to locally process training data. In some embodiments servers 112 and/or 114 may be implemented as a centralized data center providing updates and parameters for a machine learning model implemented by the client devices. Such edge computing configurations may allow for efficient data processing in that large amounts of data can be processed near the source, reducing Internet bandwidth usage. This both eliminates costs and ensures that applications can be used effectively in remote locations. In addition, the ability to process data without ever putting it into a public cloud adds a useful layer of security for sensitive data.

Edge computing functionality may also be implemented within the client devices 102-108. For example, by storing and running a machine learning model on embedded systems of a client device, such as a sensor board, inference computations may be performed independently without using a general processing chip or other computation or memory resources of the client device. Moreover, such edge computing configuration may reduce latency in obtaining results from the machine learning model.

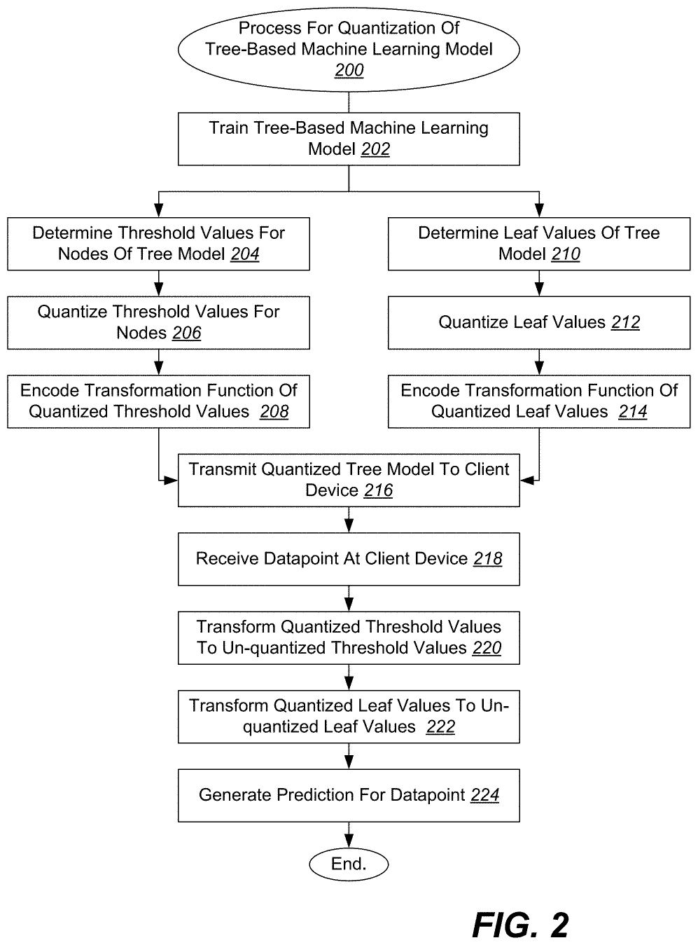

FIG. 2 illustrates a process flow chart for quantization of tree-based machine learning models, in accordance with one or more embodiments. At operation 202 a tree-based machine learning model is trained. As used herein, a tree-based machine learning model may be referred to as a “tree model.” According to various embodiments, the tree model may be any one of various tree-based machine learning models, including decision trees, and ensembles built of tree models such as random forest, and gradient boosting machines, isolation forest, etc. In some embodiments, the tree model is a classification tree. In some embodiments, the tree model is a regression tree.

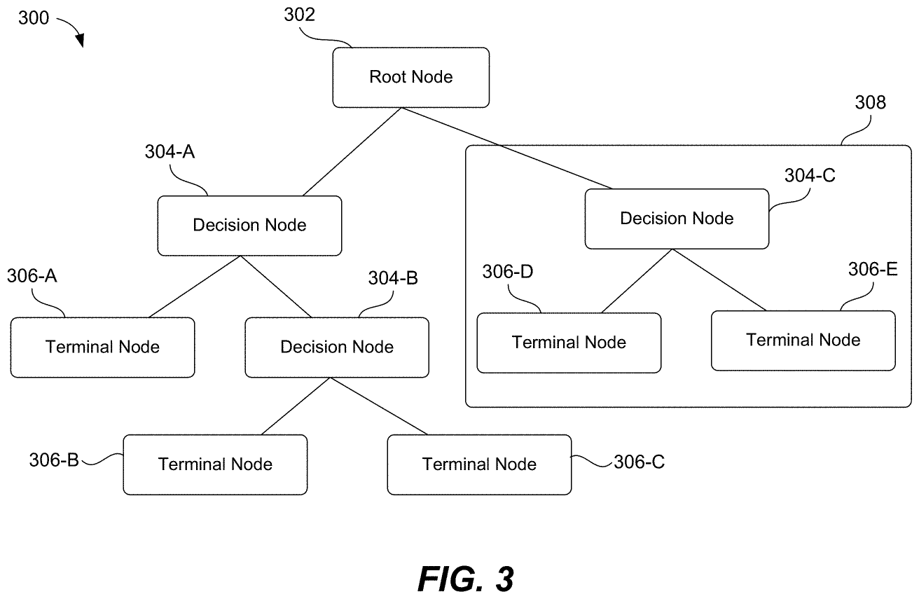

With reference to FIG. 3, shown is an example tree-based machine learning model 300, in accordance with one or more embodiments. As shown, tree model 300 may comprise various nodes, including: root node 302; decision nodes 304-A, 304-B and 304-C; and terminal nodes 306-A, 306-B, 306-C, 306-D, and 306-E. Root node 302 may represent the entire population or sample which is divided into two or more homogenous subsets represented by decision nodes 304-A and 304-B. Root node 302 may be divided by splitting the sample based on a threshold value for a particular model parameter at the root node.

Each respective portion of the sample may then be divided at each decision node based on additional model parameter thresholds until the tree model reaches a terminal node. A terminal node may also be referred to herein as a “leaf” of the tree model. A sub-section of the tree model may be referred to as a “branch” or “sub-tree.” For example, decision node 304-C and terminal nodes 306-D and 306-E make up branch 308. It should be understood that tree model 300 may comprise any number of nodes. In some embodiments, a tree model may comprise many hundreds or thousands of decision nodes.

Referring back to operation 202, different training methodologies may be implemented to train the tree model according to various embodiments. In one example, a classification and regression tree (CART) training algorithm may be implemented to select the classification parameters that result in the most homogenous splits. Various ensemble methods may also be implemented to train the tree-based machine learning model, including without limitation, bagging, adaptive boosting, and gradient boosting. These can result in ensemble models, each containing multiple trees. As such, the tree-based machine learning model may include multiple trees with more or fewer nodes and divisions that as shown in FIG. 3.

The tree model may be trained for various functions. In one example, the tree model may be trained to predict the motion of a client device. Such tree model may be implemented on an embedded device of a client device to increase accuracy of detection of movement patterns, such as on the embedded chip for an accelerometer or gyroscope of a mobile device, or on the embedded sensor hub that accepts data from an accelerometer or gyroscope on a sensor board. One example of an embedded device supported by the disclosed systems and methods may be the NANO 33 BLE board manufactured by ARDUINO which includes a 32-bit ARM® Cortex™-M4 central processing unit, and an embedded inertial sensor. For example, a particular tree model may be trained for gesture recognition tasks to differentiate between different classes of gestures. Such gestures may include an “S” shaped gesture, and a back-and-forth or “shake” gesture, for example. In such examples, a training dataset may include various accelerometer or gyroscope measurements associated with known gesture types. Other examples of embedded systems may be the SensorTile.box and STWIN development kits produced by STMicroelectronics, and the RA6M3 ML Sensor Module produced by RENESAS.

In other examples, the tree model may be trained for anomaly detection for predictive maintenance of equipment. Such tree model may receive sensor data from sensors attached to machinery or equipment that monitor vibrations, sounds, temperature, or other physical phenomena to monitor the performance and condition of equipment during normal operation to reduce the likelihood of failures. The tree model may be trained on normal operational data to classify new data as belonging to similar or dissimilar dataset. In yet another example, the tree model may be trained for voice or speech recognition to analyze audio for keyword spotting. Such tree model may be implemented on an embedded chip corresponding to a microphone on voice activated devices.

At operation 204, threshold values for decision nodes of the tree model are determined from the training. During training, a tree algorithm learns from the training data by finding feature thresholds that efficiently split the training dataset data into groups. These thresholds may then be used at inference time to categorize and make a prediction about a new datapoint. The threshold values are model parameters and contribute to the ultimate size of the model.

As such, training of the tree model may result in assignment of one or more threshold values for a feature at each decision node, at which splits to the dataset are made. In various embodiments, a decision node may result in a binary split. However, in some embodiments, a decision node may include additional splits.

For mobile device gestures, a feature may correspond to the mean accelerometer signal over a particular time window. For example, the mean value of the axis motion from the sensor may be used as a feature. For example, data from a first gesture class may tend to have a negative value for the mean axis motion on average, while data from a second gesture class may trend toward a positive or zero values for the mean axis motion on average. Because the values tend to be different, this feature can be used to efficiently split the data. Thus an example threshold for such feature may be −0.157, which is a float value.

Other relevant features for gesture recognition may include vibrational or movement frequency measurements, including zero crossing calculations of motion across a particular axis, or fast Fourier transform values. For example, the tree model may split the data based on a measure frequency of the movement. An “S” gesture may typically have an oscillatory motion frequency of 2 Hertz (Hz) or less, while a shake gesture may typically have an oscillatory motion frequency greater than 2 Hz.

The parameter values may exist within a first number space and are encoded in a first data type. For example, threshold values may be floating-point type values (referred to herein as float values or floats). In some embodiments, the threshold values are signed or unsigned integers. For example, tree models may be trained on feature values extracted from sensor data, such as from an accelerometer or gyroscope; these feature values are typically represented as floating point values, and threshold values resulting from the training would also be represented as floating point values. In some embodiments, float values are encoded as 32-bit floating-point types (float in C). However, the threshold values may be encoded as various other data types with greater or lesser data sizes or file storage sizes, such as integers, long data type, or double data type, for example.

At operation 206, the threshold values are quantized to a data type of smaller file storage size. In some embodiments, a subset of all threshold values may be quantized. The threshold values can be quantized to use smaller data types in order to make the model encoding smaller. As one example, consider a tree model with features that are float-valued. The tree model has been trained on these float-valued features, and the thresholds learned for the tree are therefore float-valued. The threshold values encoded as 32-bit floating-point types may be quantized to 8-bit unsigned integers (uint8_t in C) saving 3 bytes per threshold value. However, threshold values may be quantized to 8-bit signed integers in some embodiments. Other small data types may be implemented. For example, 32-bit floating-point types may be quantized to 16-bit unsigned integers (uint16_t in C). This would result in a smaller reduction in file size, but would preserve the information in the threshold with more fidelity than 8-bit quantization.

To quantize the thresholds, a transformation function is generated. In some embodiments, a transformation function may be generated for each feature with quantized threshold values. In some embodiments, the transformation function is invertible. The transformation function for a given feature may then be applied to all thresholds associated with that feature across the nodes where that feature is used to split the data. In some embodiments, a transformation function may be generated for a group of features, and the thresholds associated with all of the features in the group can be transformed with this transformation function.

The transformation function and its properties may depend on the type of quantization performed. For example, the transformation function may be an affine transformation, which may be a combination of rescaling and translation. This can be represented by: f(x)=mx+b. In the example above, where parameter values are quantized from 32-bit floating-point types to 8-bit unsigned integers, the threshold values for a given feature used in the model are mapped to a number space of [0, 255] with an affine transformation where the minimum threshold value maps to 0 and the maximum threshold value maps to 255. For example, the trained tree model may include fifty (50) splits, with ten of the splits based on the feature of mean value of the axis motion. The minimum value of the ten splits is mapped to 0 and the maximum value of the ten splits is mapped to 255, with the other threshold values mapped to values in between 0 and 255 in accordance with the affine transformation.

After mapping from the un-quantized [min, max] space to the quantized [0, 255] space, the thresholds are rounded to integer values, and the “quantization” process is finished. Encoding this transformation may require 2 floating-point values at 4 bytes for each feature (slope and intercept, for example). Thus, the parameter values are quantized into a second number space that is encoded in a second data type with a smaller file storage size relative to the first data type.

The transformation function is encoded at operation 208. In some embodiments, the transformation is added to the code of the tree model as an array. For example, the array may be encoded within the tree-based machine learning model, and the array stores parameters for transforming a given quantized parameter value from the smaller data type to the larger data type. In some embodiments, each feature with quantized threshold values is associated with a separate array in the tree model code.

Depending on the number of features used by the model and the number of splits (each with its own threshold), bytes can be saved overall by quantizing the thresholds to smaller data types as such. It should be recognized that values may be quantized to other known number spaces corresponding to different encoding sizes and formats. A tree model may split the dataset based on multiple different features. In some embodiments, all threshold values in a tree model are quantized. In some embodiments, only threshold values corresponding to a subset of the features are quantized. In some embodiments, threshold values corresponding to a particular feature are quantized and mapped to their own quantized space.

At operation 210, leaf values of the terminal nodes of the tree model are determined. During training, tree models learn information from the training data and store it in parameters associated with the terminal nodes, or leaves. A given “leaf” value is used at inference time to categorize the new datapoint when that datapoint reaches the given leaf. The leaf values are model parameters and contribute to the model size. Depending on the type of tree implementation, leaf values may be float-valued “margins,” or they may be integers representing the number of training instances that reached that particular leaf, or they might be float-valued ratios of the number of training instances reaching that particular leaf. It should be recognized that the leaf values may correspond to values of various data types known in the art.

At operation 212, the leaf values are quantized. In some embodiments, where the leaf values are float-valued, the leaf values may be represented by 32-bit floating-point types (float in C). Such leaf values may be quantized by encoding the leaf values as 8-bit unsigned integers (uint8_t in C) as previously described with reference to threshold values. As discussed, such quantization may save 3 bytes per leaf value.

In some embodiments, where leaf values are integer-valued, quantization may be implemented to use a smaller integer type to save bytes if the range of values that need to be represented is large enough that the smallest available integer type is not large enough to represent them. For example, if the leaf values have a range of 0 to 300, an array storing these values may require a type that is at least 16-bit, such as 16-bit unsigned integers (uint16_t in C). These values may be quantized by mapping the values to the range [0, 255], which would allow the array to be encoded by 8-bit unsigned integers (uint8_t in C). Such quantization would save 1 byte per leaf value.

For example, in a regression type tree model, leaf values may all be encoded in the same number space. In some embodiments, leaf values of a regression type tree model are all encoded in the same number space in a particular data type. Here, all leaf values may be quantized into the same number space corresponding to a data type with reduced storage size.

As another example, a classification type tree model may be implemented to categorize features from a datapoint. Categorizing the type of motion from a motion sensor (such as an “S” gesture or a shake gesture) may be a classification problem. In some embodiments, the classification type tree model may implement a random forest algorithm. In classification tree models, each leaf may provide a probability that the received datapoint is associated with a particular class of motion, such as an “S” gesture or a shake gesture. For example, each leaf may include an integer value associated with each class of gesture. A particular leaf of the classification tree model may encounter 10,000 datapoints during training that are spread out among three gesture classes: “S” gesture, shake gesture, and “W” gesture.

In one example, 50,000 datapoints may be associated with the “S” gesture, 30,000 datapoints may be associated with the shake gesture, and 20,000 datapoints may be associated with the “W” gesture. In this example, the relative values for each gesture class may be represented as a ratio or percentage (such as 50, 30, and 20 percent, or such as 5, 3, and 2). These values may be encoded in a 32-bit floating-point data types with decimal places.

The values of this particular leaf may be quantized to a number space with a smaller storage size, such as 8-bit unsigned integers. In some embodiments, values in all leaf nodes in a tree model are quantized to the same number space. However, in some embodiments, the values of different leaf nodes are quantized into separate quantized number spaces corresponding to each leaf. In yet other examples, values of multiple leaf nodes may be quantized to the same number space, while values of other leaf nodes are not quantized or are quantized to a separate number space alone or along with other leaf nodes.

At operation 214, a transformation function of the quantized leaf values is encoded. As previously described, the transformation function may be generated and encoded as an array within the code of the tree model. The transformation function and its properties may depend on the type of quantization performed. For example, the transformation function may be an affine transformation. In some embodiments, a transformation function may be generated for each set of quantized values. For example, a single transformation function may be associated with a leaf node. However, where values of multiple leaf nodes are quantized to the same number space, a single transformation function may be associated with the multiple leaf nodes. In some embodiments, encoding this transformation function requires 2 floating-point values at 4 bytes (slope and intercept, for example). However, such an array may not be required in certain quantization circumstances, because for some types of tree models it may not be necessary to transform the quantized leaf values to the un-quantized space to perform inference on the datapoint or feature. For example, quantization of integer-valued leaf parameters may not require a transformation function.

In various embodiments, other methods of mapping may be encoded within the tree model for quantized parameter values. In one example, the transformation function is a lookup table constructed from a number of quantiles (e.g., 256 quantiles) calculated from the leaf values. Each leaf score may be represented in the index of the closest quantile. Each leaf is stored as an 8-bit unsigned integer, and there is the fixed overhead of a table of 256 quantiles stored as floats. Indices are converted to floats at runtime by a table-lookup (indexing into the quantile array). A more complex transformation may reduce the amount of information lost while quantizing the model, resulting in a more faithful performance of the quantized model relative to the original un-quantized model. However, this more complex transformation requires more transformation parameters to be stored along with the model (to perform the inverse transformation at inference time), which results in less savings in terms of bytes when quantizing the model.

Quantization may be performed regardless of what task the tree model is trained on or what features are implemented. In various embodiments, operations 204-208 for threshold values and operations 210-214 for leaf values may be performed independently. In some embodiments, only threshold values may be quantized, while in other embodiments, only leaf values are quantized, depending on the type of tree model, training method, and types of values involved. This provides added flexibility in structuring the tree model to reduce the ultimate storage size of the tree model.

Due to the rounding of various values, a certain level of accuracy or information may be lost during the quantization process. Thus, in various embodiments, either quantization operations 206 or 212 may only be performed if the quantization of thresholds or leaf values will result in a reduction of the model size above a predetermined threshold. For example, the predetermined threshold may be 1000 bytes. In other words, if the quantization of all threshold values would result in a reduction of 1000 bytes of the model size, then operation 206 may be implemented. Similarly, if the quantization of leaf values would result in a reduction of at least 1000 bytes of the model size, then operation 212 may be implemented. In various embodiments, improved performance of the client device or embedded device by such reduction of file storage size will greatly outweigh any loss in accuracy caused by quantization of parameter values.

The number and type of additional transformation parameters will be implementation-dependent, but if they are needed one must take into account the additional bytes needed by these additional parameters when determining the quantized model size. In the discussed example in which 32-bit floating-point threshold values are quantized to 8-bit unsigned integers, 3 bytes are saved for each threshold value. With one threshold value for each split in the tree model, the quantization of threshold values saves 3 bytes for each split.

As previously discussed, a transformation function may require two floating-point values at 4 bytes each. Thus, in some embodiments, the transformation function added to the model increases the model size by 4 bytes per linear parameter, with two linear parameters per feature. In other words, the transformation function may increase the model size by 8 bytes per feature. Thus, in order to reduce the ultimate size of the tree model, the following condition must be satisfied:

(number of features)(8 bytes)<(number of splits)(3 bytes)

This ensures that the size of the tree model may be adequately reduced to implement the tree model on a client device. In various embodiments, it is beneficial to implement the tree model on an embedded chip rather than a general-purpose processing unit. For example, a mobile phone may be in a stand-by state with the screen off and the general-purpose chip asleep (saving power). In such stand-by state, the microphone of the mobile device may remain active, and the microphone chip (a low-power “embedded” chip that controls the microphone and the audio data coming from it) may have a quantized machine learning model, as described, running on it. The quantized machine learning model may be trained to identify a keyword from an audio stream and wake up the device if it determines that the keyword has been spoken. Once the mobile device is awake, the general-purpose processing unit may be implemented to perform more intensive operations, such as executing a more powerful machine learning model to perform voice recognition on the audio stream. In this way, the device can “listen” for the keyword while the general-purpose processing unit is asleep, reducing overall power usage.

The quantized tree model is then transmitted to the client device at operation 216 and stored in memory on the client device. In some embodiments, the tree model is transmitted with quantized threshold values and/or quantized leaf values, along with the corresponding transformation function for the quantized space. In some embodiments, the tree model is transmitted to the flash memory or other storage corresponding to an embedded chip. However, in some embodiments, the tree model is stored on any accessible memory of the client device. The tree model may then be accessed by the central processing unit or other embedded chip to make predictions during an inference mode.

In some embodiments, the system may implement a cloud-based machine learning model in which the tree model is trained and developed at a central server or edge computing device and pushed to the client device or embedded chip. This would allow a user to select different trained tree models to push to the embedded systems of multiple client devices without using local computing power of the client devices to train and develop the selected model.

During operation in the inference mode, a datapoint may be received at operation 218. In the aforementioned example, such datapoint may be obtained from sensor data from an accelerometer or gyroscope of a mobile device. One or more features, or feature values, may be extracted from the datapoint. For example, the data point may indicate an amount of movement in one or more axes, a frequency of movement, a number of movements in a particular axis, etc. As another example, the datapoint may be obtained from a microphone, camera, or other sensor of a mobile device. In some embodiments, the extracted feature includes a value associated with the first number space corresponding to the un-quantized parameter values. For example, the features extracted from the datapoint are float-valued (32-bit floating point valued).

The extracted feature may then be passed through the tree model in order to generate a prediction for the feature. In order to compare or process an extracted feature during the inference mode, the quantized threshold values are transformed into un-quantized threshold values at operation 220. In some embodiments, the quantized threshold values are transformed back to the original data type with the same dimensions. For example, 8-bit unsigned integers are transformed back to the original data type, such as 32-bit floating-point type values or 16-bit unsigned integers. The processor may transform the quantized threshold values based on the stored transformation function (i.e., encoded array) of the tree model. Once the relevant parameter values are transformed from the second number space back to the first number space, the extracted feature can be compared to the un-quantized parameter values in the first number space and directed to the appropriate nodes of the tree model.

In various embodiments, the tree model is stored on the embedded system or client device in the quantized format, and is un-quantized at inference time, to maintain a reduced model size on the embedded system. The particular implementation of un-quantization during inference time is flexible and may depend on the amount of available Random Access Memory (RAM) or working memory. In some embodiments, the parameter values of a particular decision node or leaf node are un-quantized as needed. For example, parameter values may be un-quantized as the extracted feature is processed at a particular node or nodes corresponding to the parameter values. Any potential increased latency caused by the additional un-quantization operations during implementation are outweighed by resulting improvements in performance, such as a decrease in flash and RAM memory usage. In some embodiments, the parameter values for all nodes corresponding to a particular transformation function are un-quantized during inference time. In yet other embodiments, all parameter values are un-quantized during inference time. Un-quantizing all or multiple parameters values at once may increase RAM requirements, but would reduce flash memory usage and decrease latency during implementation.

Once the threshold values have been un-quantized, an extracted feature is passed through the decision nodes of the tree model to generate a prediction at a terminal node. In some embodiments, quantized leaf values are transformed into un-quantized leaf values at operation 222, and a prediction is generated for the feature of the datapoint upon reaching a terminal node at operation 224. A prediction may then be output by the tree model for the extracted feature or datapoint.

In various embodiments, operation 222 is an optional operation implemented in order to use the leaf value to make a prediction. However, in some tree model implementations, transformation of quantized leaf values at operation 222 is not required. For example, in a classification type tree model, a prediction may be generated based on the relative values of the parameters at the leaf node. In such cases, the relative values of the parameters in a quantized space may be the same as in an un-quantized space. As such, the prediction may be generated without un-quantizing the leaf values. In this case, the transformation function is not needed at inference time, and so the transformation parameters do not need to be stored with the model on the device.

In some embodiments, the datapoint or feature values of the datapoint are quantized into the same number space and data type as the quantized threshold values during inference operations. In such examples, the quantized datapoint may be passed through the tree model without un-quantizing the threshold values or leaf values.

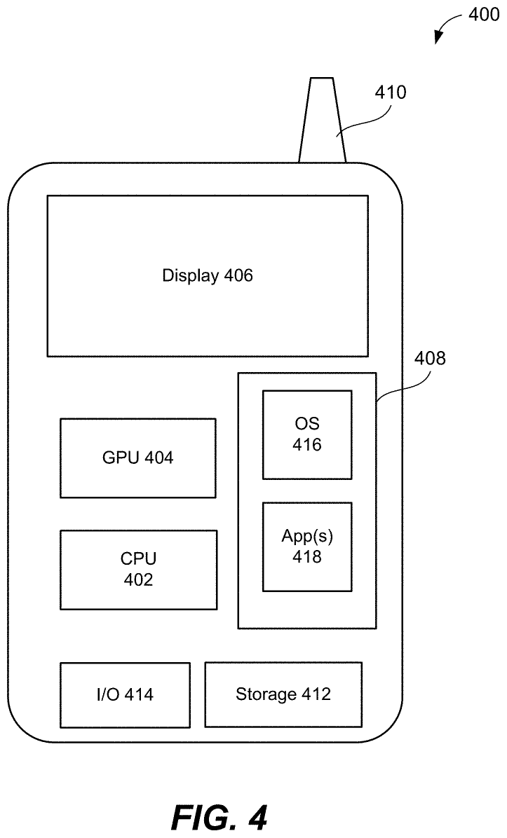

FIG. 4 depicts the architecture of a client device 400 that can be used to realize the present teaching as a specialized system. In this example, the user device on which a quantized tree model may be implemented is a mobile device 400, such as but not limited to, a smart phone, a tablet, a music player, a hand-held gaming console, or a global positioning system (GPS) receiver. The mobile device 400 in this example includes one or more central processing units (CPUs) 402, one or more graphic processing units (GPUs) 404, a display 406, memory 408, a communication platform 410 (such as a wireless communication module), storage 412, and one or more input/output (I/O) devices 414. Any other suitable component, such as but not limited to a system bus or a controller (not shown), may also be included in the mobile device 400.

I/O devices may include various sensors, microphones, gyroscopes, accelerometers, and other devices known in the art. Such I/O devices may include embedded systems, processors, and memory which may implement the quantized tree models described herein. In some embodiments, the processor of the embedded system may include specialized hardware for processing machine learning models, including un-quantizing parameter values. However, in some embodiments, quantized tree models may be stored in storage 412 or memory 408. In some embodiments, quantized tree models and described methods may be implemented by the CPU of the client device.

As shown in FIG. 4, a mobile operating system (OS) 416, e.g., iOS, Android, Windows Phone, etc., and one or more applications 418 may be loaded into the memory 408 from the storage 412 in order to be executed by the CPU 402. The applications 418 may include a browser or other application that enables a user to access content (e.g., advertisements or other content), provides presentations of content to users, monitors user activities related to presented content (e.g., whether a user has viewed an advertisement, whether the user interacted with the advertisement in other ways, etc.), reports events (e.g., throttle events), or performs other operations. In some embodiments, applications 418 may rely on, or utilize, output results of the quantized tree models.

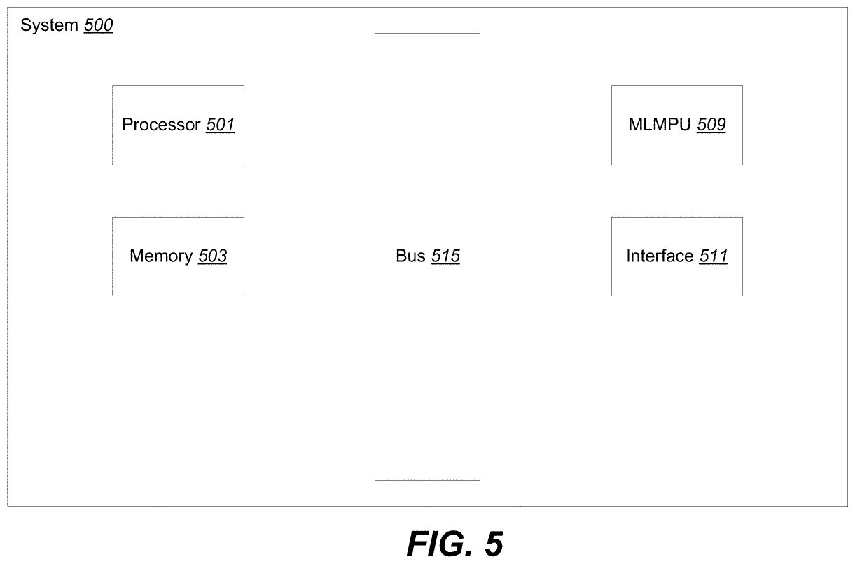

With reference to FIG. 5, shown is a particular example of a computer system that can be used to implement particular examples of the present disclosure. For instance, the computer system 500 may represent a client device, server, or other edge computing device according to various embodiments described above. According to particular example embodiments, a system 500 suitable for implementing particular embodiments of the present disclosure includes a processor 501, memory 503, an interface 511, and a bus 515 (e.g., a PCI bus or other interconnection fabric).

The interface 511 may include separate input and output interfaces, or may be a unified interface supporting both operations. The interface 511 is typically configured to send and receive data packets or data segments over a network. Particular examples of interfaces the device supports include Ethernet interfaces, frame relay interfaces, cable interfaces, DSL interfaces, token ring interfaces, and the like. Generally, these interfaces may include ports appropriate for communication with the appropriate media. In some cases, they may also include an independent processor and, in some instances, volatile RAM. The independent processors may control such communications-intensive tasks as packet switching, media control and management.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications-intensive tasks as packet switching, media control and management.

According to particular example embodiments, the system 500 uses memory 503 to store data and program instructions and maintained a local side cache. The program instructions may control the operation of an operating system and/or one or more applications, for example. The memory or memories may also be configured to store received metadata and batch requested metadata.

When acting under the control of appropriate software or firmware, the processor 501 is responsible for such tasks such as implementation and training of a machine learning tree model, and quantizing or un-quantizing parameter values of the tree model. Various specially configured devices can also be used in place of a processor 501 or in addition to processor 501. The complete implementation can also be done in custom hardware.

In some embodiments, system 500 further comprises a machine learning model processing unit (MLMPU) 509. As described above, the MLMPU 509 may be implemented for such tasks such as implementation and training of a machine learning tree model, quantizing or un-quantizing parameter values of the tree model, and carrying out various operations, as described in FIG. 2. The MLMPU may be implemented to process a trained tree model to identify parameter values for threshold parameters and leaf nodes, and determine one or more appropriate quantized number spaces for the parameter values. In some embodiments, the machine learning model processing unit 509 may is a separate unit from the CPU, such as processor 501.

Because such information and program instructions may be employed to implement the systems/methods described herein, the present disclosure relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the disclosure. It is therefore intended that the disclosure be interpreted to include all variations and equivalents that fall within the true spirit and scope of the present disclosure.

What is claimed is:

1. A method for quantization of tree model parameters, the method comprising:
determining one or more parameter values in a trained tree-based machine learning model, wherein the one or more parameter values exist within a first number space encoded in a first data type;
quantizing the one or more parameter values into a second number space, wherein the second number space is encoded in a second data type having a smaller file storage size relative to the first data type;
encoding an array within the tree-based machine learning model, wherein the array stores parameters for transforming a given quantized parameter value in the second number space to a corresponding parameter value in the first number space; and
transmitting the tree-based machine learning model to a client device.

2. The method of claim 1, wherein the tree-based machine learning model is transmitted to an embedded system of the client device.

3. The method of claim 2, further comprising:
obtaining a datapoint via a sensor of the embedded system;
extracting a feature from the datapoint;
passing the extracted feature through the tree-based machine learning model;
un-quantizing the one or more parameter values from the second number space to the first number space; and
generating a prediction for the feature based on the one or more un-quantized parameter values.

4. The method of claim 3, wherein each of the one or more parameter values are un-quantized as needed as the extracted feature is processed at nodes corresponding to the one or more parameter values.

5. The method of claim 1, wherein the one or more parameter values correspond to threshold values for a feature of the tree-based machine learning model.

6. The method of claim 1, wherein the one or more parameter values correspond to leaf values of the tree-based machine learning model.

7. The method of claim 1, wherein the first data type is a 32-bit floating-point type.

8. The method of claim 1, wherein the second data type is an 8-bit unsigned integer.

9. The method of claim 1,
wherein the one or more parameter values correspond to threshold values for a feature and leaf values of the tree-based machine learning model; and
wherein threshold values and leaf values are quantized independently from one another.

10. The method of claim 1, wherein the tree-based machine learning model is configured to classify gestures corresponding to motion of the client device.

11. A system for quantization of tree model parameters, the system comprising:
one or more processors, memory, and one or more programs stored in the memory, the one or more programs comprising instructions for:
determining one or more parameter values in a trained tree-based machine learning model, wherein the one or more parameter values exist within a first number space encoded in a first data type;
quantizing the one or more parameter values into a second number space, wherein the second number space is encoded in a second data type of a smaller file size relative to the first data type;
encoding an array within the tree-based machine learning model, wherein the array stores parameters for transforming a given quantized parameter value in the second number space to a corresponding parameter value in the first number space; and
transmitting the tree-based machine learning model to a client device.

12. The system of claim 11, wherein the tree-based machine learning model is transmitted to an embedded system of the client device.

13. The system of claim 12, wherein the one or more programs comprise further instructions for:
obtaining a datapoint via a sensor of the embedded system;
extracting a feature from the datapoint;
passing the extracted feature through the tree-based machine learning model;
un-quantizing the one or more parameter values from the second number space to the first number space; and
generating a prediction for the feature based on the one or more un-quantized parameter values.

14. The system of claim 13, wherein each of the one or more parameter values are un-quantized as needed as the extracted feature is processed at nodes corresponding to the one or more parameter values.

15. The system of claim 11, wherein the one or more parameter values correspond to threshold values for a feature of the tree-based machine learning model.

16. The system of claim 11, wherein the one or more parameter values correspond to leaf values of the tree-based machine learning model.

17. One or more non-transitory computer readable media having instructions stored thereon for performing a method, the method comprising:
determining one or more parameter values in a trained tree-based machine learning model, wherein the one or more parameter values exist within a first number space encoded in a first data type;
quantizing the one or more parameter values into a second number space, wherein the second number space is encoded in a second data type of a smaller file size relative to the first data type;
encoding an array within the tree-based machine learning model, wherein the array stores parameters for transforming a given quantized parameter value in the second number space to a corresponding parameter value in the first number space; and
transmitting the tree-based machine learning model to a client device.

18. The one or more non-transitory computer readable media of claim 17, wherein the tree-based machine learning model is transmitted to an embedded system of the client device.

19. The one or more non-transitory computer readable media of claim 18, wherein the method further comprises:
obtaining a datapoint via a sensor of the embedded system;
extracting a feature from the datapoint;
passing the extracted feature through the tree-based machine learning model;
un-quantizing the one or more parameter values from the second number space to the first number space; and
generating a prediction for the feature based on the one or more un-quantized parameter values.

20. The one or more non-transitory computer readable media of claim 19, wherein each of the one or more parameter values are un-quantized as needed as the extracted feature is processed at nodes corresponding to the one or more parameter values.
